(19) United States
(12) Patent Application Publication
(10) Pub. No.: US 2024/0427395 A1
(43) Pub. Date: Dec. 26, 2024

(54) POWER SEQUENCER FOR POWER STATE MANAGEMENT

(71) Applicant: Google LLC, Mountain View, CA (US)

(72) Inventors: Ronak Subhas Patel, Sunnyvale, CA (US); William James Tuohy, Danville, CA (US); Vinu Vijay Kumar, Belmont, CA (US); Alex Robert Carlson, Sunnyvale, CA (US)

(21) Appl. No.: 18/577,002

(22) PCT Filed: Jul. 16, 2021
(86) PCT No.: PCT/US2021/042077

§ 371 Date: Jan. 5, 2024

(51) Int. Cl. G06F 1/26

(52) U.S. Cl. CPC G06F 1/266

(57) ABSTRACT

Methods, systems, and apparatus for handling applications in an ambient computing system. One of the apparatus includes multiple devices arranged in multiple power blocks, wherein each device of the multiple devices belongs to one of the multiple power blocks; and multiple local power managers, each local power manager being programmable to execute respective sets of instruction sequences for a respective power block in order to effectuate power state transitions for one or more devices in the respective power block.

### BACKGROUND

This specification relates to systems having integrated circuit devices.

A system on a chip (SoC) is an integrated circuit that integrates different components of a mobile computing device, including a central processing unit (CPU), memory, input/output ports, cellular radios, and secondary storage, and so on. In contrast to the traditional motherboard-based PC architecture, where a motherboard houses and connects detachable or replaceable components, SoCs integrate all these components into a single integrated circuit. SoCs are commonly used in mobile computing, edge computing, and embedded systems, such as smartphones, tablet computers, WiFi routers, Internet of Things (IoT) devices, and so on.

A SoC can include multiple devices that need power management. Power management manages power state transitions for each device to optimize power consumption and utilization, such as achieving longer battery life, and reducing power wastage. For example, when a CPU is in an idle state, the system can change the power state of the CPU to a low power state (e.g., switching to a lower voltage) in order to reduce the power consumption. Power management can include turning on/off the power, controlling voltage or frequency, switching to a low-power state when inactive, and so on.

Power management for SoC is typically performed by using a state machine or a micro-controller. A state machine is a hardware based solution that implements power state transitions in the hardware. Although a state machine based solution provides fast state transitions and takes a smaller silicon area, the state machine based solution limits the ability to make changes and to debug issues after the chip is manufactured. A micro-controller based solution uses a generic purpose micro-controller and implements power state transitions in software. Although a micro-controller based solution provides better flexibility for modification and debugging, the micro-controller based solution results in longer power state transitions. In addition, because the micro-controller based solution uses a generic micro-controller with a large instruction memory and a large data memory along with debug/trace infrastructure, this often limits the number of instances of micro-controllers in one SoC and a SoC typically only has one micro-controller that manages the power states of all devices in the SoC.

### SUMMARY

This specification describes technologies for implementing local power managers for power state management. Each local power manager is configured to execute custom instructions defined for power management that effectuate the sequences of hardware transitions required to transition from one power state to a next power state. Relative to instructions executed by a generic microcontroller, the custom instructions are small in size and are specially defined for power management tasks. A local power manager can respond to a received triggering event and can run the custom instructions to perform a power state transition in response to the triggering event.

The subject matter described in this specification can be implemented in particular embodiments so as to realize one or more of the following advantages. By using dedicated specially designed instruction sequences for power management, the local power manager provides faster state transitions while also providing flexibility for modification and debugging. That is, the local power manager can achieve the performance/response latency of a hardware-based solution as well as the flexibility and programmability of a micro-controller. In contrast to a generic computing device (e.g., a micro-controller) that includes a large number of functionalities, the local power manager can maintain a small set of instructions and does not need to include the mathematical operations. Unlike micro-controller based solutions, the local power manager can have direct access to hardware level signals for debugging. One SoC can integrate multiple local power managers that can independently control the power state of multiple devices or subsystems on the chip. Rather than having one local power manager for each device in the SoC, the SoC can include a local power manager that manages power state transitions of multiple devices that are logically part of the same sub-system, and therefore enables sharing of common resources and reducing power consumption and in-silicon area consumption. Therefore, the local power managers can achieve the performance of a state machine based solution and the flexibility of a micro-controller based solution, while having similar area consumption as a state machine based solution.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example computing device.

FIG. 2 is a diagram of an example local power manager.

FIG. 3 is a diagram of an example power state transition diagram.

FIG. 4 is a diagram of an example power sequencer.

FIG. 5 is a flowchart of an example process for power management using a power sequencer.

Like reference numbers and designations in the various drawings indicate like components.

### DETAILED DESCRIPTION

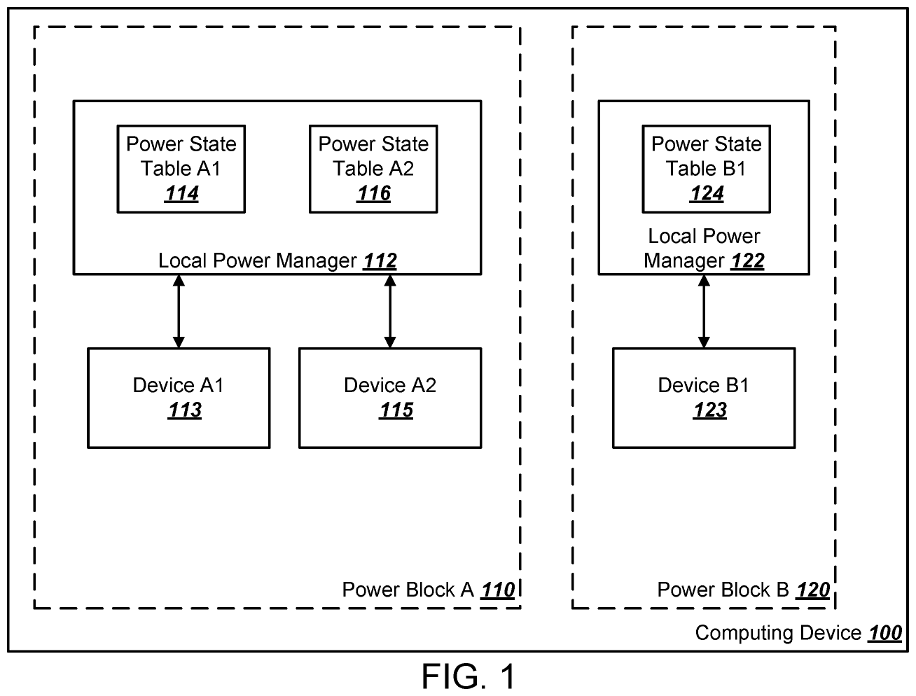

FIG. 1 is a diagram of an example computing device 100. The computing device 100 can be a system on a chip (SoC) device installed on a mobile device (e.g., a smart phone or a tablet). A SoC is an integrated circuit that includes each component of the system on a single silicon substrate or on multiple interconnected dies, e.g., using silicon interposers, stacked dies, or interconnect bridges.

The computing device 100 includes multiple devices that have different power requirements under different states. For example, when a user starts the camera app on a mobile device, a SoC can power on an image processor that is integrated into the SoC. When the camera app is closed, the SoC can power down the image processor.

Examples of the multiple devices include one or more central processing units (CPU), one or more tensor processing units (TPU), one or more sensors, one or more displays, and so on. The computing device 100 can include a large number of such devices, e.g., 10, 50, or 100 devices. The computing device 100 in FIG. 1 is simplified for illustration, and includes three devices: device A1 (113), device A2 (115), and device B1 (123).

At any given time, each device is in a particular power state. The power state indicates the level of power consumption (e.g., the extent of computing activity) of the device. Examples of power state can include Active, Run Fast, Run Slow, Hibernate, and so on. The power state of the device changes as needed to conserve power consumption. The computing device 100 performs power management to manage the power state transitions for each device and optimizes power consumption of the mobile device.

The multiple devices in the computing device 100 are arranged in multiple power blocks. A power block includes a group of devices and the power management of the group of devices can be correlated, e.g., the group of devices can be powered up or powered down together. Multiple devices in the same power block can be logically dependent and can belong to part of the same sub-system. For example, the computing device 100 includes two power blocks: power block A (110) and power block B (120). Device A1 (113) and device A2 (115) belong to power block A (110), and device B1 (123) belongs to power block B (120).

The computing device 100 includes multiple local power managers (LPMs) that operate independently. Each local power manager can be programmed to execute respective sets of instruction sequences for a respective power block. Each local power manager can manage the power state transitions for one or more devices in the respective power block. Each local power manager can control each device in the respective power block to transit from one power state to another power state.

For example, the computing device includes a local power manager 112 for power block A (110) and a local power manager 122 for power block B (120). Local power manager 112 can manage the power state transitions for device A1 and device A2. Local power manager 122 can manage the power state transition for device B1.

Rather than having a single micro-controller that controls all the devices in the computing device 100, the computing device 100 includes multiple LPMs that each control one or more devices independently. Compared with a micro-controller based solution, the power sequencer based solution can reduce latency and delay by using multiple local power managers to control the power state transitions of multiple devices in the chip independently.

Each local power manager can execute power state transitions based on multiple power state tables. Each power state table stores possible power state transitions for a respective device. Each power state transition changes the power state from an initial state to the next state. For example, local power manager 112 can store power state table A1 (114) and power state table A2 (116). Power state table A1 stores multiple power state transitions for device A1. Power state table A2 stores multiple power state transitions for device A2. Local power manager 112 can execute transition sequences generated by the power state table A1 (114) to perform the power state transition of device A1 (113). Local power manager 112 can execute transition sequences generated by the power state table A2 (114) to perform the power state transition of device A2 (113).

Multiple different power state tables controlled by the same LPM can interact with each other and can have dependencies. For example, synchronization can be performed among the power states and/or power state transitions of device A1 and device A2 that are controlled by the same LPM 112. As another example, a power state transition for device A1 can depend on a specific power state transition of device A2.

Compared with a state machine based solution, the local power manager can be modified after the computing device 100 is manufactured, i.e., post-silicon. For example, suppose the power management of device A2 (115) depends on the current power state of device A1 (113). After the chip has been manufactured and has been running for a while, if the device A1 (113) is no longer being used, the local power manager 112 can be reprogrammed such that the power management logic of device A2 (115) no longer depends on the power state of device A1. Instead of having to remanufacture the entire chip in the case of a state machine based power management solution, the power sequencer based solution can provide the flexibility for modification post-silicon.

As another example, when an error is found in the power management instructions during or after manufacturing time, the local power manager can be reprogrammed to remove the error from the instructions rather than remanufacturing the chip. As another example, when an engineer develops an improvement in the power management after the chip is manufactured, the engineer can reprogram the local power manager without a need to remanufacture the chip. New power states due to changes in product specifications or other optimization can be added after the chip is manufactured. For example, after the chip is manufactured, new power states can be identified through optimizational experiments in the lab, and these new power states can be added by reprogramming the local power manager.

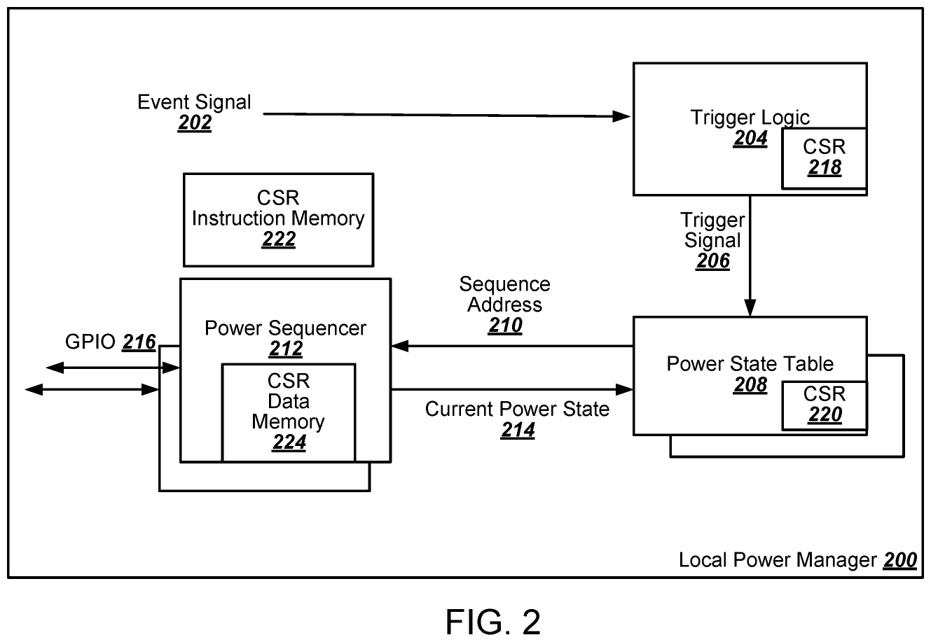

FIG. 2 is a diagram of an example local power manager (LPM) 200. The local power manager 200 is a configurable power manager to control power state transitions for one or more devices in a computing device 100, e.g., devices in a SoC. The local power manager 200 includes trigger logic 204, one or more power state tables 208, and one or more power sequencers 212. The trigger logic 204 is configured to receive event signals 202 as an input and output trigger signals 206. The one or more power state tables 208 are configured to store a mapping between trigger signals 206 and power state transitions. The one or more power sequencers 212 are configured to execute respective instruction sequences when a power state transition is triggered by the trigger signal 206.

The local power manager 200 takes an event signal 202 as input and generates one or more trigger signals 206 using the trigger logic 204. An event signal can include one or more input signals that can be logically combined to trigger power state transitions. The event signal 202 can include multiple event signals for a plurality of events. Events of the event signal 202 can include external events or software events that trigger power state transitions. Examples of external events include inputs from General Purpose Input/Output (GPIO), system timer, requests from other LPMs, interrupts, core logic related to a power transition (e.g. reducing power consumption if no activity), data obtained from one or more sensors of the computing device 100, and so on. An event signal that includes a logic value can be in an ON state or an OFF state. In some implementations, each event signal can be enabled or disabled via Control and Status Register (CSR). In some implementations, an event signal can be assumed to be Active High when the event signal is generic, and if the event signal received by the LPM is Active Low, it can be inverted to Active High via the CSR.

The trigger logic 204 can include a sequence of operators, e.g., an AND operator, an OR operator, etc., that are inter-connected to perform a sequence of logic operations on the multiple event signals 202 and to generate one or more trigger signals 206. In some implementations, the last operator of the sequence of operators can include an “AND or OR selection” operator that determines the trigger signal 206. For example, if one or more events request a higher power state, it is desirable to generate a trigger signal for a higher power state by using an OR selection. As another example, if none of the events requests a higher power state, it is desirable to generate a trigger signal for a lower power state by using an AND selection.

The trigger logic 204 can be configured to generate a flexible number of trigger signals 206 depending on the number of trigger signals defined in the power state table 208. For example, event signal 202 for N events can be used to generate M trigger signals 206.

The LPM 200 includes one or more power state tables 208 that defines power state transitions for multiple devices controlled by the LPM 200. Each power state table 208 is configured to store a mapping between trigger signals 206 and power state transitions. Each power state table 208 defines possible power states and power state transitions from the current state 214 to the next state for a device managed by the LPM. The current power state 214 can be obtained by the power sequencer 212 from a GPIO 216 input.

For example, as shown in FIG. 1, power state table A1 (114) defines the power states and power state transitions for device A1 (113). A power state table 208 takes the trigger signal 206 and current power state 214 as input and generates a sequence address 210 as an output. The sequence address 210 is the address of an instruction sequence that can be used by the power sequencer 212 to execute the power state transition corresponding to the received trigger signal 206.

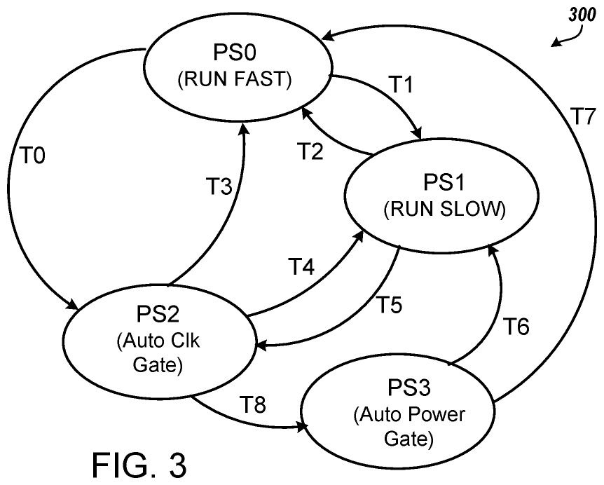

FIG. 3 is a diagram of an example power state transition diagram 300. The device (e.g., device A1 in FIG. 1) has four power states, PS0 (Run Fast), PS1 (Run Low), PS2 (Auto Clk Gate), and PS3 (Auto Power Gate). Power states PS0 and PS1 are active states running at different frequencies. Power states PS2 and PS3 are low power states. That is, PS0 is the highest power state and PS3 is the lowest power state. There are eight different triggers, T0 to T8, which can be activated using external events through the trigger logic 204. For example, the trigger TO can be generated in response to an IDLE condition of a predetermined length, and the trigger TO can be used to generate a power state transition from an active power state (PS0) to a low power state (PS2). In some implementations, a trigger can cause the device to change to a different power state or stay in the same power state.

Table 1 shows an example of a power state table 208. The power state table 208 describes a power state transition diagram in tabular form. For example, the power state table in Table 1 describes the power state transition diagram depicted in FIG. 3. The power state table includes multiple rows and each row corresponds to a current power state. For example, the power state table in Table 1 includes four possible current power states: PS0, PS1, PS2, and PS3. The power state table also includes multiple triggers that can trigger the power state transition from the current power state to the next power state. The power state table can define a predetermined number of triggers for each power state. For example, the power state table in Table 1 allows a maximum of four triggers for each power state. If a device is currently at state PS0, in response to a trigger signal of TO, the power state of the device will transit from PS0 to PS2, and in response to a trigger signal of T1, the power state of the device will transit from PS0 to PS1.

TABLE 1
An Example of a Power State Table

| | | | | |
|---|---|---|---|---|
| Current State | Trigger_A | Trigger_B | Trigger_C | Trigger_D |

| | | | |
|---|---|---|---|
| PS0 | T0 (PS2) | T1 (PS1) | |
| PS1 | T2 (PS0) | T5 (PS2) | |
| PS2 | T3 (PS0) | T4 (PS1) | T8 (PS3) |
| PS3 | T6 (PS1) | T7 (PS0) | |

Referring back to FIG. 2, The LPM 200 can include one or more power state tables to control power states of multiple devices that are logically part of the same sub-system. For example, the LPM 200 in FIG. 2 includes two power state tables that can be configured to control power states of two devices. Grouping the power state management of multiple devices can reduce power consumption and area consumption associated with an LPM. Rather than having multiple LPMs, a single LPM can better combine common resources, such as sharing the same instruction memory and sharing the same data memory.

The LPM 200 includes one or more power sequencers 212. The one or more power sequencers 212 are configured to execute respective instruction sequences when a power state transition is triggered by the trigger logic 204. Each power sequencer corresponds to a respective power state table 208 that defines the power state transition for a respective device. When there are multiple power state tables 208 in an LPM, the number of power sequencers 212 are the same as the number of power state tables 208. For example, the LPM 200 includes two power sequencers 212 and two power state tables 208, and each power sequencer corresponds to a respective power state table.

The power sequencer 212 defines multiple instruction sequences and each instruction sequence includes custom instructions defined for power state management. That is, each instruction sequence is a computer program that can be executed to perform a power state transition from one power state to the next power state. The instructions in the instruction sequence can include several categories, such as toggling output, waiting for input value with a predetermined timeout period, branching instructions, and so on. In some implementations, the instruction sequence can drive and examine GPIOs to perform multiple actions, such as handshakes, protocols, and controls.

The GPIO 216 output includes the instruction sequence defined at the sequence address 210 for a power state transition. Each power sequencer 212 controls a respective device through its respective GPIO 216. For example, the LPM 200 in FIG. 2 includes two power sequencers 212 and two GPIO 216, and each power sequencer can have its own GPIO.

In some implementations, the instructions can include functionalities for debugging a power state transition, such as single-step debugging, break point debugging, and so on. Compared with a state machine based solution in which the low-level signals are not available, in a power sequencer based solution, the signals in the power state transition process can be exposed and can be accessible by a software program. Unlike micro-controller based solutions that do not have access to the low-level signals, the local power manager can have direct access to hardware level signals for debugging. For example, the current state of the signals can be obtained and used for debugging. In some implementations, an application programming interface (API) of examining and using these signals can be defined. A hardware designer can use the API to perform debugging. In some implementations, the same API can be defined for multiple LPMs in the computing device 100. A hardware designer can use the same API to perform debugging based on signals from different LPMs.

In some implementations, the LPM can be configured to execute conditional instructions and the LPM can perform arithmetic operations without using hardware. For example, the LPM can control the movement of data by manipulating the GPIO inputs and GPIO outputs and can achieve real time response and reduce latency. As another example, the LPM might lack hardware that performs mathematical operations, such as an addition operation. In this way, the instruction set in the LPM can have a small size, resulting in improved performance.

The LPM 200 can be preconfigured with trigger logic 204, power state tables 208 and instruction sequences defined at design time. In some implementations, these components of LPM 200 can be implemented in CSRs. For example, the trigger logic 204 can be implemented in CSR 218, the power state table 208 can be implemented in CSR 220, and the power sequencer can include data memory implemented in CSR 224 and instruction memory implemented in CSR 222.

As the number of power states and the number of power state tables increases, the power state management of the computing device 100 can become more complex. Therefore, the trigger logic, the power state table, and instruction sequence needs to be updated or modified as needed. One or more of the trigger logic 204, power state tables 208, and power sequencer 212 (e.g., instruction sequences) can be modified as needed if updates are required post-silicon (i.e., after the computing device 100 is manufactured). The trigger logic, the power state tables, and the instruction sequences can be reprogrammed independently.

In some implementations, the LPM can be preconfigured or modified using a toolchain. The toolchain provides an application programming interface (API) to define variables and operations for power management, e.g., the trigger logic, the power states, and the transitions between the power states, etc. The API of the toolchain provides software interfaces similar to a high level programming language (e.g., python, Java, C#, etc.) that uses natural language elements. Instead of programming in a low level programming language (e.g., assembler level programming that involves manipulating binary values and location of the registers), a hardware designer can conveniently design the LPM and generate updates to the LPM using the API defined in the toolchain. For example, the LPM can be updated using the API to increase the wait time, to change the order of a sequence of operations, to skip a step in a sequence of steps, and so on. The toolchain can convert the software program to binary values that represent a new instruction sequence. The binary values can be uploaded and configured into the chip such that the LPM can run the new instruction sequence.

In some implementations, the updates to these components can be performed through CSR programming using the LPM toolchain. The post-silicon updates to CSR can be implemented by updating the LPM toolchain inputs and running the toolchain to generate new values for the CSRs. The new values for the CSRs can be written to the CSRs by incorporating the new values in the software to be written to the CSRs.

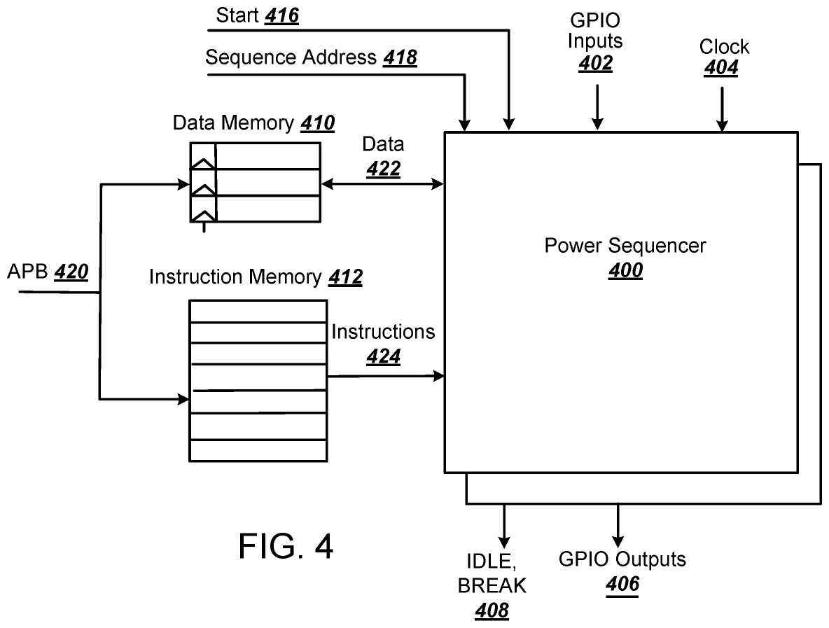

FIG. 4 is a diagram of an example power sequencer 400. The power sequencer 400 takes a sequence address 418 and GPIO inputs 402 as input and generates the GPIO outputs 406. The power sequencer 400 generates the GPIO outputs 406 based on the instruction 424 stored in instruction memory 412 and data stored in data memory 410. In some implementations, the power sequencer 400 can generate an IDLE or break 408 as output. All inputs and outputs are registered and synchronous with regard to the clock 404.

The power sequencer 400 can obtain data 422 by accessing the data memory 410 using the sequence address 418. The power sequencer 400 can obtain instructions 424 by accessing the instruction memory 412 using the sequence address 418. Both the data memory 410 and the instruction memory 412 can have zero cycle latency from address to data and instructions, and therefore, the power sequencer 400 can achieve fast power state transitions. The power sequencer decodes the instructions 424 obtained from indexing the instruction memory 412, and executes the decoded instructions to perform the power state transitions.

For example, the power sequencer 400 can obtain a set of instructions 424 for a power state transition from PS0 (Run Fast) to PS1 (Run Slow) in response to a trigger signal T1 as depicted in FIG. 3. An example of the instructions 424 can include the following:

```
q-ch
wait_or ( )
if accept
  wait( )
  halt(PS1)
else if deny
  wait( )
  halt(PS0).
```

In some implementations, when a LPM includes multiple power sequencers, the power sequencers can share common resources, such as the data memory 410 and the instruction memory 412. This helps reduce the area consumption that is needed by the LPM, i.e., the LPM takes a smaller silicon area. For example, the two power sequencers 400 shown in FIG. 4 can share the same data memory 410 and the same instruction memory 412. This can be useful when two or more devices share the same power states but operate independently. For example, two CPUs can share the same power states and the two CPUs can operate independently. The two CPUs can each have its own power sequencer and the two power sequencers can share the same data memory and the same instruction memory.

When not actively operating, the power sequencer 400 can be in an IDLE status, waiting for a start pulse 416 to start executing instructions 424. When the power sequencer 400 receives a start pulse 416, the power sequencer 400 can take sequence address 418 and start executing instructions 424. In some implementations, when the power sequencer receives a HALT instruction, the power sequencer turns into the IDLE status and stops executing instructions.

The local power manager can define a predetermined number of generic inputs and generic outputs, i.e., the GPIO inputs 402 and the GPIO outputs 406. For example, the LPM can define 64 generic inputs and 64 generic outputs.

In some implementations, when a LPM includes multiple power sequencers, the power sequencers can execute their respective instructions independently. Each power sequencer can have its own dedicated GPIO inputs 402 and GPIO outputs 406. For example, if there are multiple power sequencers inside a single LPM, there will be more than 64 generic inputs and more than 64 generic outputs.

The instructions 424 can include a computer program that is specifically designed for the power state management. The LPM can define a predetermined number of instructions, e.g., twenty instructions total. The instructions 424 can be specifically designed to perform various operations to control the power state of the device, such as quiescing the power, turning on the power, turning off the power, clamping the power, toggling one or more outputs (e.g., toggling the GPIO), waiting for one or more inputs (e.g., waiting for acknowledgement from a clock controller), and taking an action based on an input. In some implementations, the instructions 424 can be designed to take a branching action depending on the value of the input and an ability to timeout in case that an abortion or error condition is satisfied.

In some implementations, the instructions 424 can be variable in length. Some instructions can be encoded based on major opcodes, e.g., based on size of operands, while some instructions can be encoded based on minor opcodes, e.g., based on actual size of the instruction. For example, simple instructions can be encoded based 16-bits in size while more complex instructions can be 32-bits in size. In some implementations, the instructions 424 can include one or more operands that represent the values of event signal 202 received by the trigger logic 204. The event signal 202 can include input and output signals that interface with the system and can control the power state transitions of the system. For example, the event input signals can trigger the execution of the instruction sequences. The instruction sequences can operate on a set of input or output signals to implement various protocols to control the power state transitions.

In some implementations, the instructions 424 can provide debugging functionalities for debugging the power state transitions. For example, the instructions 424 can provide functionalities such as adding break points and performing a single-step debugging.

The LPM 200 is programmable and can be updated post-silicon by connecting to software programs through an advanced peripheral bus (APB) port 420. The software programs can be generated using an API defined in an LPM toolchain. The software programs can access the CSRs in the LPM through the ABP port 420. For example, the software programs can access the CSR 218 for the trigger logic 204, CSR 220 for the power state table 208, CSR for the data memory 224, and CSR for the instruction memory 222 through the ABP port 420, and the data stored in these CSRs can be updated or modified by the software programs.

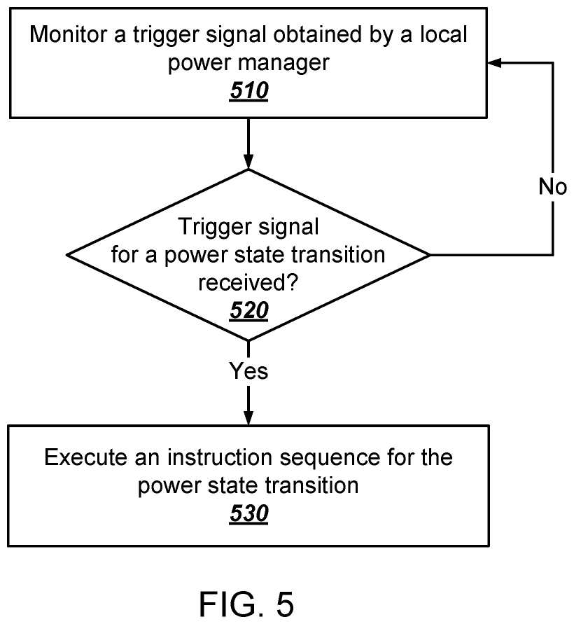

FIG. 5 is a flowchart of an example process for power management using a power sequencer. For convenience, the process will be described as being performed by a system that includes one or more local power managers in the computing device 100. The system can include the components described in reference to FIG. 1, including one or more devices, one or more power state tables, trigger logic, one or more power sequencers, or some combination of these.

The system monitors a trigger signal obtained by a local power manager (510). The system can monitor the trigger signal at a predetermined interval. For example, the system can enter into a main loop that checks event signals received by the LPM every 5 milliseconds. The system can receive one or more event signals 202 and the system can generate one or more trigger signals 206 using the trigger logic 204 in the LPM 200.

The system determines whether the trigger signal is a trigger signal for a power state transition for a device in the system (520). The system can determine whether the trigger signal is a trigger signal for a power state transition based on the power state table 208 of the device and the current power state 214 of the device. In some implementations, the system can monitor power state transition needs for multiple devices in the computing device 100. The system can determine whether the trigger signal triggers power state transition for each device based on each device's respective power state tables 208 and each device's respective current power state 214. For example, based on the power state table in Table 1, when the current power state of a device is in PS0, the system can determine that a trigger signal T1 is a trigger signal for a power state transition from PS0 (Run Fast) to PS1 (Run Slow).

If the system determines that the trigger signal is not a trigger signal for a power state transition, the system continues monitoring a future trigger signal obtained by the local power manager (510).

If the system determines that the trigger signal is a trigger signal for a power state transition, the system executes an instruction sequence for the power state transition (530). The system can generate a sequence address 210 of the instruction sequence based on the power state table 208. The system can use a power sequencer to determine the instructions 424 for the instruction sequence by indexing the instruction memory 412 using the sequence address 210. The power sequencer can generate GPIO outputs 406 based on the instructions 424, and the GPIO outputs 406 can be used to perform the power state transition of a device. In some implementations, the system can include a respective power sequencer and a respective power state table for each of the multiple devices in the computing device 100. The system can generate respective GPIO outputs for each of the multiple devices.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

To provide for interaction with a user, embodiments of the subject matter described in this specification can be implemented on, or configured to communicate with, a computer having a display device, e.g., a LCD (liquid crystal display) monitor, for displaying information to the user, and an input device by which the user can provide input to the computer, e.g., a key board and a pointing device, e.g., a mouse, a trackball or touchpad. Other kinds of devices can be used to provide for interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client device having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a computing device comprising:
multiple devices arranged in multiple power blocks, wherein each device of the multiple devices belongs to one of the multiple power blocks; and
multiple local power managers, each local power manager being programmable to execute respective sets of instruction sequences for a respective power block in order to effectuate power state transitions for one or more devices in the respective power block.

Embodiment 2 is the computing device of embodiment 1, wherein each local power manager comprises:
trigger logic configured to receive event signal inputs and output trigger signals;
a power state table configured to store a mapping between trigger signals and power state transitions; and
one or more hardware sequencers configured to execute respective instruction sequences when a power state transition is triggered by the trigger logic.

Embodiment 3 is the computing device of embodiment 2, wherein the power state table, the trigger logic, and the instruction sequences are modifiable after the computing device is manufactured.

Embodiment 4 is the computing device of embodiment 2, wherein the hardware sequencer comprises break point and single-step functionality for debugging.

Embodiment 5 is the computing device of embodiment 2, wherein the instruction sequences comprise instructions having one or more operands that represent values of event signal inputs received by the trigger logic, wherein the event signal inputs control the power state transitions.

Embodiment 6 is the computing device of embodiment 1, wherein each local power manager is configured to execute conditional instructions but lacks hardware to perform arithmetic operations.

Embodiment 7 is the computing device of embodiment 1, wherein each local power manager is configured to execute transition sequences for multiple power state tables of multiple respective devices.

Embodiment 8 is a computer implemented method, comprising:
monitoring a trigger signal obtained by a local power manager, wherein multiple devices in a computing device are arranged in multiple power blocks, wherein each device of the multiple devices belongs to one of the multiple power blocks, wherein each of multiple local power managers is programmable to execute respective sets of instruction sequences for a respective power block;
determining whether a trigger signal for a power state transition is received; and
in response to determining that the trigger signal for the power state transition is received, executing an instruction sequence for the power state transition for one or more devices in the respective power block.

Embodiment 9 is the computer implemented method of embodiment 8, wherein each local power manager comprises:
trigger logic configured to receive event signal inputs and output trigger signals;
a power state table configured to store a mapping between trigger signals and power state transitions; and
one or more hardware sequencers configured to execute respective instruction sequences when a power state transition is triggered by the trigger logic.

Embodiment 10 is the computer implemented method of embodiment 9, wherein the power state table, the trigger logic, and the instruction sequences are modifiable after the computing device is manufactured.

Embodiment 11 is the computer implemented method of embodiment 9, wherein the hardware sequencer comprises break point and single-step functionality for debugging.

Embodiment 12 is the computer implemented method of embodiment 9, wherein the instruction sequences comprise instructions having one or more operands that represent values of event signal inputs received by the trigger logic, wherein the event signal inputs control the power state transitions.

Embodiment 13 is the computer implemented method of embodiment 8, wherein each local power manager is configured to execute conditional instructions but lacks hardware to perform arithmetic operations.

Embodiment 14 is the computer implemented method of embodiment 8, wherein each local power manager is configured to execute transition sequences for multiple power state tables of multiple respective devices.

Embodiment 15 is one or more non-transitory storage media encoded with instructions that when executed by one or more local power managers of a computing device arranged into multiple power blocks cause the one or more local power managers to effectuate power state transitions for multiple devices in respective power blocks of the computing device, wherein each of the multiple devices belongs to one of the multiple power blocks.

Embodiment 16 is the non-transitory storage media of embodiment 15, wherein each local power manager comprises:
trigger logic configured to receive event signal inputs and output trigger signals;
a power state table configured to store a mapping between trigger signals and power state transitions; and
one or more hardware sequencers configured to execute respective instructions when a power state transition is triggered by the trigger logic.

Embodiment 17 is the non-transitory storage media of embodiment 16, wherein the power state table, the trigger logic, and the instructions are modifiable after the computing device is manufactured.

Embodiment 18 is the non-transitory storage media of embodiment 16, wherein the hardware sequencer comprises break point and single-step functionality for debugging.

Embodiment 19 is the non-transitory storage media of embodiment 16, wherein the instructions comprise instructions having one or more operands that represent values of event signal inputs received by the trigger logic, wherein the event signal inputs control the power state transitions.

Embodiment 20 is the non-transitory storage media of embodiment 15, wherein each local power manager is configured to execute conditional instructions but lacks hardware to perform arithmetic operations.

While this specification contains many specific implementation details, these should not be construed as limitations on the scope of any invention or on the scope of what is being or may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computing device comprising:
multiple devices arranged in multiple power blocks, wherein each device of the multiple devices belongs to one of the multiple power blocks; and
multiple local power managers, each local power manager being programmable to execute respective sets of instruction sequences for a respective power block in order to effectuate power state transitions for one or more devices in the respective power block.

2. The computing device of claim 1, wherein each local power manager comprises:
trigger logic configured to receive event signal inputs and output trigger signals;
a power state table configured to store a mapping between trigger signals and power state transitions; and
one or more hardware sequencers configured to execute respective instruction sequences when a power state transition is triggered by the trigger logic.

3. The computing device of claim 2, wherein the power state table, the trigger logic, and the instruction sequences are modifiable after the computing device is manufactured.

4. The computing device of claim 2, wherein the hardware sequencer comprises break point and single-step functionality for debugging.

5. The computing device of claim 2, wherein the instruction sequences comprise instructions having one or more operands that represent values of event signal inputs received by the trigger logic, wherein the event signal inputs control the power state transitions.

6. The computing device of claim 1, wherein each local power manager is configured to execute conditional instructions but lacks hardware to perform arithmetic operations.

7. The computing device of claim 1, wherein each local power manager is configured to execute transition sequences for multiple power state tables of multiple respective devices.

8. A computer implemented method, comprising:
monitoring a trigger signal obtained by a local power manager, wherein multiple devices in a computing device are arranged in multiple power blocks, wherein each device of the multiple devices belongs to one of the multiple power blocks, wherein each of multiple local power managers is programmable to execute respective sets of instruction sequences for a respective power block;
determining whether a trigger signal for a power state transition is received; and
in response to determining that the trigger signal for the power state transition is received, executing an instruction sequence for the power state transition for one or more devices in the respective power block.

9. The computer implemented method of claim 8, wherein each local power manager comprises:
trigger logic configured to receive event signal inputs and output trigger signals;
a power state table configured to store a mapping between trigger signals and power state transitions; and
one or more hardware sequencers configured to execute respective instruction sequences when a power state transition is triggered by the trigger logic.

10. The computer implemented method of claim 9, wherein the power state table, the trigger logic, and the instruction sequences are modifiable after the computing device is manufactured.

11. The computer implemented method of claim 9, wherein the hardware sequencer comprises break point and single-step functionality for debugging.

12. The computer implemented method of claim 9, wherein the instruction sequences comprise instructions having one or more operands that represent values of event signal inputs received by the trigger logic, wherein the event signal inputs control the power state transitions.

13. The computer implemented method of claim 8, wherein each local power manager is configured to execute conditional instructions but lacks hardware to perform arithmetic operations.

14. The computer implemented method of claim 8, wherein each local power manager is configured to execute transition sequences for multiple power state tables of multiple respective devices.

15. One or more non-transitory storage media encoded with instructions that when executed by one or more local power managers of a computing device arranged into multiple power blocks cause the one or more local power managers to effectuate power state transitions for multiple devices in respective power blocks of the computing device, wherein each of the multiple devices belongs to one of the multiple power blocks.

16. The non-transitory storage media of claim 15, wherein each local power manager comprises:
trigger logic configured to receive event signal inputs and output trigger signals;
a power state table configured to store a mapping between trigger signals and power state transitions; and
one or more hardware sequencers configured to execute respective instructions when a power state transition is triggered by the trigger logic.

17. The non-transitory storage media of claim 16, wherein the power state table, the trigger logic, and the instructions are modifiable after the computing device is manufactured.

18. The non-transitory storage media of claim 16, wherein the hardware sequencer comprises break point and single-step functionality for debugging.

19. The non-transitory storage media of claim 16, wherein the instructions comprise instructions having one or more operands that represent values of event signal inputs received by the trigger logic, wherein the event signal inputs control the power state transitions.

20. The non-transitory storage media of claim 15, wherein each local power manager is configured to execute conditional instructions but lacks hardware to perform arithmetic operations.
